(19) United States
(12) Patent Application Publication
(10) Pub. No.: US 2016/0032149 A1
(43) Pub. Date: Feb. 4, 2016

(54) AEROSPACE DECAL

(71) Applicant: Laurence E. Tighe, Seattle, WA (US)

(72) Inventor: Laurence E. Tighe, Seattle, WA (US)

(73) Assignee: GM NAMEPLATE, INC., Seattle, WA (US)

(21) Appl. No.: 14/815,814

(22) Filed: Jul. 31, 2015

Related U.S. Application Data
(60) Provisional application No. 62/031,609, filed on Jul. 31, 2014.

(51) Int. Cl. C09J 7/02; B32B 27/36; B32B 37/00; B32B 7/06

(52) U.S. Cl. CPC C09J 7/0285; B32B 7/06; B32B 27/36; B32B 37/025; B32B 2451/00; B32B 2605/18; B32B 2255/26; B32B 2405/00; B32B 2255/10; C09J 2201/606; C09J 2467/006; C09J 2203/334; C09J 2203/10; C09J 201/00

(57) ABSTRACT

A decal is suitable for application to an aircraft structure that is covered with an incompletely cured base coat of paint. The decal has a polyester film with an adhesive applied to a first side. A release layer is applied to the polyester film and comprises a pattern engaging the adhesive to form a plurality of grooves in the adhesive layer. When the decal is applied to an uncured base coat of paint, offgasses formed during curing and drying of the base coat escape from beneath the decal through the grooves.

### CROSS-REFERENCE TO RELATED APPLICATION

This application claims the benefit of U.S. Provisional Patent Application No. 62/031,609, filed Jul. 31, 2014, the disclosure of which is incorporated by reference herein in its entirety.

### BACKGROUND

Primer and paint are often applied to aircraft structure to provide a protective coating, as well as an aesthetically pleasing decorative finish. The primer and paint layers are typically applied to metal or composite structure. In addition to enhancing the ornamental appearance of the aircraft, decals applied to the paint can also provide information, such as warnings, instructions, etc. using symbols and other indicia.

Decals typically include an adhesive layer to secure the decal to the aircraft structure. When a decal is applied, gasses can form under the decal due to air entrapment between decal and painted surface, the slow curing of the paint underneath, the chemical interaction of the adhesive with the incompletely cured paint surface to which it is applied, or various other chemical reactions, depending upon the chemical properties of the materials utilized. The gasses can in turn form bubbles under the decals that are aesthetically unpleasing and can impact the durability of the decals. Accordingly, there is a need for decals that, when applied to an aircraft structure, minimize or eliminate the formation of bubbles between the decal and the aircraft surface.

### SUMMARY

A disclosed embodiment of decal is applied to an aircraft structure that is covered with an incompletely cured base coat of paint. The decal includes a polyester film with an adhesive applied to a first side. A release layer is applied to the polyester film and comprises a pattern engaging the adhesive to form a plurality of grooves in the adhesive layer. When the decal is applied to an incompletely cured base coat of paint, offgasses formed during curing and drying of the base coat escape from beneath the decal through the grooves.

Also disclosed is an exemplary method of applying a decal to an aircraft structure that is covered with an incompletely cured base coat of paint. The method includes the step of removing a release layer from an adhesive surface of the decal to expose at least one groove formed in the adhesive layer by the release layer. The method further includes the step of applying the decal to the aircraft structure so that the adhesive adheres to the incompletely cured base coat of paint, wherein offgasses under the decal travel through the at least one groove to an edge of the decal. With the decal applied to the structure, a paper or polymer film application mask is removed from the decal, and a sprayed on 2 part urethane clear coat is applied.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a cross-sectional view of a decal in accordance with one exemplary embodiment of the present disclosure; and

FIG. 2 shows an isometric view of a release coat of the decal of FIG. 1.

### DETAILED DESCRIPTION

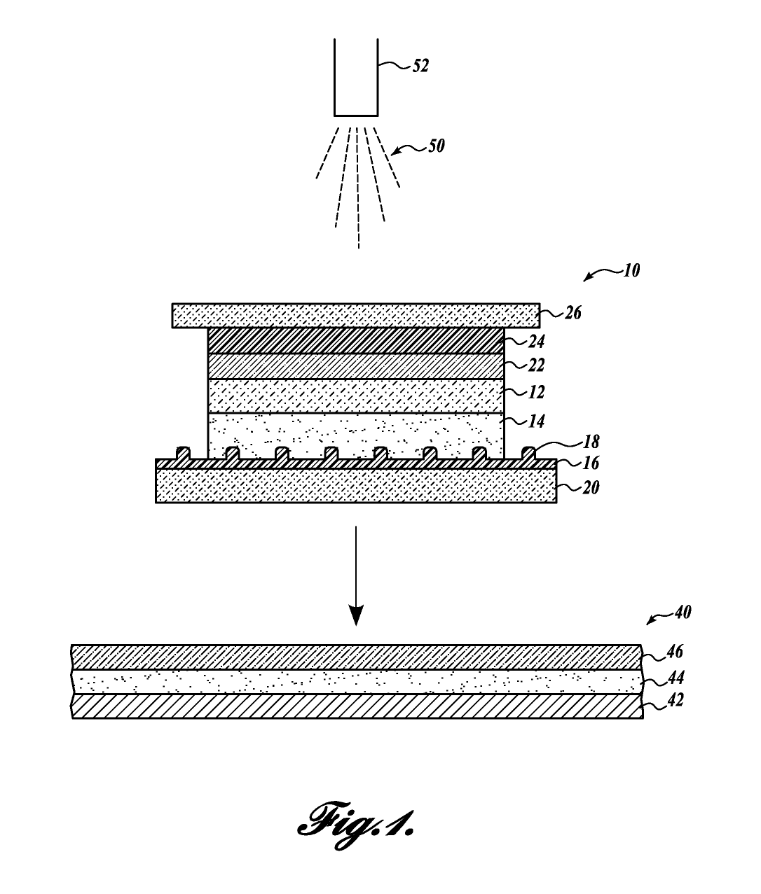

FIG. 1 shows a cross-sectional view of a decal 10 suitable for application to the outer surface of an aircraft structure 40. In the illustrated embodiment, the aircraft structure includes an aluminum skin, typically a 6061-T6 or 2024-T3. It will be appreciated that the presently disclosed decals 10 are not limited for use on aluminum skins. In this regard, the decals 10 can be used on any suitable structure made from any generally known material, and the use of the decals with such structures and materials should be considered within the scope of the present disclosure.

A coat of primer 44 is applied to the cleaned and treated aluminum skin 42, and a base coat 46 of polyurethane paint is applied over the primer. The primer 44, which is preferably a 2-part epoxy, inhibits corrosion and also provides a surface to which the base coat 46 of the paint will better adhere. The base coat is preferably a 2-part polyurethane paint, although it will be appreciated that any number of suitable paints and coatings may be utilized.

The decal 10 is formed on a plastic film 12, such as, for example, a polyester film. The polyester film 12 acts as the base of the decal 10. A pressure sensitive adhesive 14 is disposed on one side of the polyester film 12, and a release coat 16 is applied to the adhesive 14 so that the adhesive is sandwiched between the polyester film 12 and the release coat.

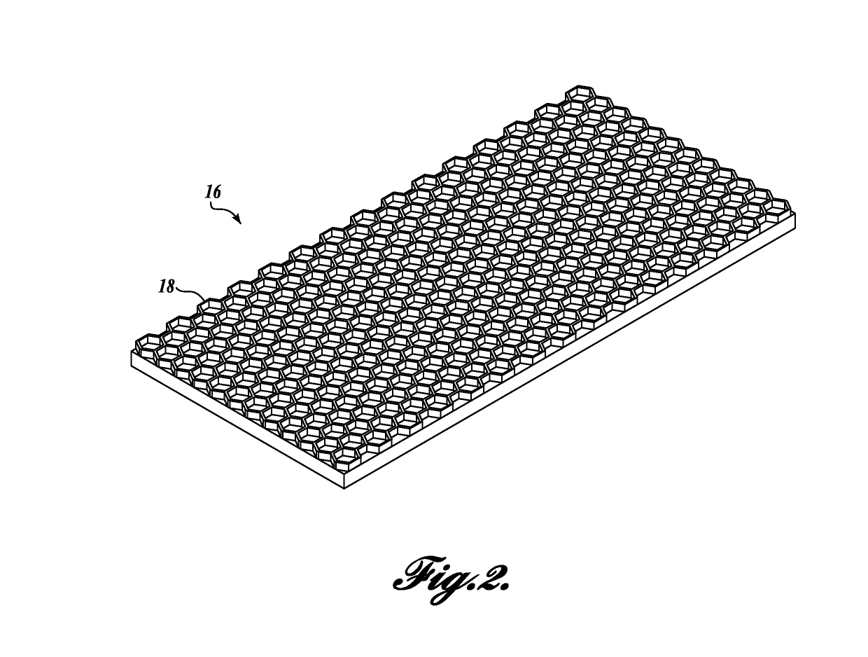

The release coat 16 is preferably made from silicone or other suitable material to allow for easy removal from the adhesive layer 14. The release coat 16 has a raised pattern 18 formed on the surface. The pattern 18 includes a series of raised ridges preferably in a honeycomb or diamond shaped pattern when viewed from above; however, it will be appreciated that the pattern is not limited to these shapes and can include any other suitable shapes or combinations thereof. FIG. 2 shows an exemplary embodiment of a release coat 16 with an embossed honeycomb pattern 18.

The pattern 18 on the release coat 16 engages the adhesive layer 14 so that when the release coat 16 is removed from the adhesive layer, indentations from the pattern remain in the adhesive layer. That is, a negative of the pattern 18 is formed on the adhesive layer 14. The negative of the pattern 18 is defined by a series of grooves, at least some of which extend to the edge of the adhesive layer 14.

A liner 20 is attached to the release coat 16 opposite the adhesive layer 14. The liner 20 is formed from paper, plastic film, or any other material suitable for providing protection to the release coat 16 during manufacture and handling of the decal 10 prior to application of the decal.

The film 12, adhesive layer 14, release coat 16, and liner 20, can be assembled as part of the decal manufacturing process. Alternately, commercially available products can be used. Non-limiting examples of suitable products include 3M SCREEN PRINTABLE POLYESTER PERFORMANCE LABEL PRODUCTS 7218SA and 7220SA, both of which include a structured adhesive layer.

On the surface of the polyester film 12, a graphic layer 22 is formed. The graphic layer 22 is preferably formed from a polyester ink that has been combined with a crosslinking agent. The use of a crosslinking agent, such as isocyanate for example, improves adhesion as well as resistance to damage from abrasion, heat, and water.

A polyurethane clear tie coat 24 is applied to the graphic layer 22. The clear tie coat 24 serves as a tie layer between (1) the sprayed on 2-part polyurethane clear coat 50 (described later) applied to the aircraft surface and (2) the decal 10, which has been applied to the base coat 46 of the aircraft structure. The tie layer function of the decal's clear tie coat allows good wet out and adhesion by multiple versions of sprayed on 2-part urethane clear coats 50. The clear tie coat 24 also provides additional protection to the graphic layer of the decal, but is translucent or, preferably, transparent, to allow the graphic layer to be visible through the clear tie coat. A paper or polymer film application mask 26 is applied over the clear tie coat 24 to protect the decal prior to application and to facilitate application.

Application of the decal 10 to the aircraft structure 40 will now be described. The decal 10 is applied while the base coat 46 is preferably dry to the touch, but still not completely dried and cured, i.e., the paint feels solid to the human touch, but there are still solvents present in the paint. Also, the chemical reaction between the polyol contained in the paint and the isocyanate mixed with the paint has not come to completion. The liner 20 and release layer 16 are removed from the back of the decal 10, leaving the grooved adhesive layer 14 exposed. The decal is applied to the structure 40, and a 2-part polyurethane clear coat 50 is applied over the decal 10 by a sprayer 52.

As the base coat 46 continues to dry and cure, paint solvents evaporate and outgas, and carbon dioxide evolves and outgases as a product of isocyanate hydrolysis. Specifically, the reaction of water (ever present except in a vacuum) and the isocyanate in the paint creates carbon dioxide. Additional carbon dioxide may be produced from small side reactions. For existing decals, the carbon dioxide and evaporating solvents can collect under the decal, forming undesirable bubbles. For the presently disclosed decal 10, the grooves formed in the adhesive layer 14 provide a path to the edge of the decal. The carbon dioxide and evaporating solvents migrate to the edge of the decal through the grooves to minimize or prevent the formation of bubbles.

In the disclosed embodiment, various trim procedures are optionally performed to facilitate application of the decal 10. Referring to FIG. 1, after all of the layers except for the paper or polymer film application mask 26 have been assembled, the decal 10 is kiss-cut to remove excess material. That is, the layers from the clear tie coat 24 to the adhesive layer 14 are trimmed. The release coat 16 and liner 20 are left untrimmed or are trimmed so that the release coat and liner extend from the perimeter of the adhesive layer 14. As a result, the pattern 18 on the release coat 16 is at least partially visible around the edges of the decal 10. The paper or polymer film application mask 26 is then laminated over the decal 10 and kiss-cut to be slightly larger than the decal.

When the decal 10 is kiss-cut as illustrated, a user can easily peel off the liner 20 (and release coat 16) while holding the paper or polymer film application mask 26. The decal 10 can then be placed on the aircraft structure surface with the paper or polymer film application mask 26 on. The paper or polymer film application mask 26 is very thin and translucent, so the user can see the placement of the decal 10 through the mask. The paper or polymer film application mask 26 also allows a user to smooth out the decal without touching it or the clear tie coat 24. Once user is satisfied with decal placement, the paper or polymer film application mask 26 is removed, and the 2-part polyurethane clear coat 50 can be applied by sprayer 52.

While the preferred embodiment of the invention has been illustrated and described, it will be appreciated that various changes can be made therein without departing from the spirit and scope of the invention. In this regard, while exemplary embodiments are described with reference to decals applied to aircraft structure, it will be appreciated that the present disclosure is not limited to decals for aircraft structure but includes any other application of decals. Further, the chemical properties of the described decal layers and the surfaces to which they are applied are exemplary only and should not be considered limiting. In this regard, the chemical properties of the decal and application surface, and the chemical interaction therebetween, can vary and such variations should be considered within the scope of the present disclosure.

1. A decal for an aircraft structure, the aircraft structure being covered with an incompletely cured base coat of paint, the decal comprising:
(a) a polyester film;
(b) an adhesive applied to a first side of the polyester film; and
(c) a release layer applied to the polyester film, the release layer comprising a pattern engaging the adhesive to form a plurality of grooves in the adhesive layer; wherein when the decal is applied to an incompletely cured base coat of paint, offgasses formed during curing and drying of the base coat move from beneath the decal through the grooves.

2. The decal of claim 1, further comprising ink applied to a second side of the polyester film to form a design.

3. The decal of claim 2, wherein the ink is a polyester ink.

4. The decal of claim 3, further comprising a crosslinking agent mixed with the polyester ink.

5. The decal of claim 4, wherein the crosslinking agent comprises isocyanate.

6. The decal of claim 2, further comprising a clear tie coat applied to the polyester ink and crosslinking agent.

7. The decal of claim 6, wherein the clear tie coat is a polyurethane clear coat.

8. A method of applying a decal to an aircraft structure covered with an incompletely cured base coat of paint, the method comprising:
(a) removing a release layer from an adhesive surface of the decal to expose at least one groove formed in the adhesive layer by the release layer;
(b) applying the decal to the aircraft structure so that the adhesive adheres to the incompletely cured base coat of paint, wherein offgasses under the decal travel through the at least one groove to an edge of the decal;
(c) removing an application mask from the decal; and
(d) applying a sprayed on 2-part urethane clear coat over the decal and surrounding aircraft structure.
